(19) United States
(12) Patent Application Publication
(10) Pub. No.: US 2015/0072335 A1
(43) Pub. Date: Mar. 12, 2015

(54) SYSTEM AND METHOD FOR PROVIDING AUGMENTATION BASED LEARNING CONTENT

(71) Applicant: Tata Consultancy Services Limited, Mumbai (IN)

(72) Inventors: NIRANJAN PEDANEKAR, Pune (IN); Vijayanand Mahadeo Banahatti, Pune (IN); Shirish Subhash Karande, Pune (IN); Varun Kumar, Pune (IN); Abhay Tanaji Doke, Pune (IN)

(73) Assignee: Tata Consultancy Services Limited

(21) Appl. No.: 14/477,192

(22) Filed: Sep. 4, 2014

(30) Foreign Application Priority Data
Sep. 10, 2013 (IN) 2915/MUM/2013

(51) Int. Cl. G09B 5/02

(52) U.S. Cl. CPC G09B 5/02
USPC 434/362

(57) ABSTRACT

The present subject matter discloses a system and a method for providing augmented based learning content to a user. In one embodiment, based on a learning source accessed by the user, the system is enabled to extract topics for retrieving learning content from online or offline resources such as the Internet or a system database, respectively. Thus, the learning source may be augmented by retrieving the learning content from the online or offline sources. Further, information layers may be generated based on topics/subjects being read by the user. The generated information layers may be populated with the retrieved learning content. The system may be enabled for matching the learning content populated in the information layers with a profile of the user stored in a user profile database. Based on the matching, the learning content may be delivered to the user. The delivered learning content may be personalized to the user.

### CROSS-REFERENCE TO RELATED PATENT APPLICATIONS

This U.S. patent application claims the benefit of priority under 35 U.S.C. §119 to India Patent Application No. 2915/MUM/2013, filed on Sep. 10, 2013. The aforementioned application is incorporated herein by reference in its entirety.

### TECHNICAL FIELD

The present subject matter described herein, in general, relates to a method and a system for providing augmentation based learning content.

### BACKGROUND

Education plays a key role in the development of a nation and thus, it is considered as a backbone for the nation's development. With the advent of the Internet, online learning has been utilized as an alternative to conventional learning and has been implemented successfully across the globe. A number of online learning systems have been developed and are being used for facilitating the education of the global population. Through the use of the online learning systems, providing personalized learning has become possible. However, in developing countries like India where pupil-per-teacher ratio is high, implementing the personalized learning is a major challenge. Personalized learning requires creating a variety of learner-specific learning content and also updating such learning content based on the learner's requirements.

In today's learning environment, the learners may still have to rely on learning sources such as physical text books, articles, research papers, white papers, e-articles, e-books, video courses, presentations, Internet web pages, intranet web pages, computer-based training (CBT) courses, learning management software (LMS) etc., authorized or recommended by various authorizing bodies including universities, educational institutes, and educational boards etc. Such dependency on these learning sources may reduce the viability of online learning systems. Moreover, learning sources such as physical text books add more technical challenges and limitations for online learning systems. These challenges restrict the learner from grasping a term, phrase, sentences or any topic which he/she may be reading for that instance. Each time, the learner may have to visit various online sources to get the proper answer for his/her queries. These deviations may reduce the learner's concentration as well as consume significant amounts of time.

Even though, various online learning tools may be available for providing learning content from the different online sources, the arrangement of such learning content in a structured manner may be another challenge. With the increase in the number of learners and the number of subjects/topics, online learning systems may also have to face various scalability issues.

### SUMMARY

This summary is provided to introduce aspects related to systems and methods for providing augmentation based personalized learning content and the concepts are further described below in the detailed description. This summary is not intended to identify essential features of subject matter nor is it intended for use in determining or limiting the scope of the subject matter.

In certain embodiments, a system for delivering learning content to a user is disclosed. The system comprises a memory device and at least one processor, wherein the memory device stores a set of modules, and wherein the at least one processor executes the modules. The modules may include an extracting module, a generating module, a search module, a populating module, and a delivery module. The extracting module may be configured to identify a page of a learning source being accessed by the user. In one embodiment, the extracting module may be further configured to extract at least one topic from the page. The topic may be associated with a subject of the user's interest. The generating module may be configured to generate one or more information layers corresponding to the topic. In one embodiment, the one or more information layers indicate an abstraction of information relating to the topic. The generating module may be further configured to generate a profile of the user based on one or more attributes indicating a learning style of the user. The search module may be configured search for one or more resources based on the topic. In one embodiment, the search results in retrieval of the learning content. The populating module may be configured to populate the one or more information layers with the learning content. The delivery module may be configured to deliver the learning content to the user based upon the profile of the user. In one embodiment, the learning content is delivered via the one or more information layers.

In certain embodiments, a method for delivering a learning content to a user is disclosed. The method may be performed by at least one processor. The method may include identifying a page of a learning source being accessed by the user. Further, the method may include extracting at least one topic from the page, the topic being associated with a subject of the user's interest. The method may also include generating one or more information layers corresponding to the topic, the one or more information layers indicating an abstraction of information relating to the topic. The method may further include generating a profile of the user based on one or more attributes indicating a learning style of the user. Moreover, the method may include searching for one or more resources based on the topic, the search resulting in retrieval of the learning content. Further, a method may include populating the one or more information layers with the learning content. Additionally, the method may include delivering, via the one or more information layers, the learning content to the user based on the profile of the user.

Yet in another implementation a non-transitory computer readable medium storing machine readable instructions. The instructions may be executable by one or more processors for identifying a page of a learning sources being accessed by a user. Further, the instructions may executable by the one or more processors for extracting at least one topic from the page, the topic being associated with a subject of the user's interest. Additionally, the instructions may be executable by the one or more processors for generating one or more information layers corresponding to the topic, the one or more information layers indicating an abstraction of information relating to the topic. The instructions may also be executable by the one or more processors for generating a profile of the user based on one or more attributes indicating a learning style of the user. The instructions may further be executable by the one or more processors for searching for one or more resources based on the topic, the search resulting in retrieval of the learning content. Further, the instructions may be executable by the one or more processors for populating the one or more information layers with the learning content. Moreover, the instructions may be executable by the one or more processors for delivering, via the one or more information layers, the learning content to the user based on the profile of the user.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to refer like features and components.

FIG. 1 illustrates a network implementation of a system for providing augmentation based learning content, in accordance with certain embodiments of the present subject matter.

FIG. 2 illustrates the system, in accordance with certain embodiments of the present subject matter.

FIGS. 3 and 4 illustrate a detailed working of the system, in accordance with certain embodiments of the present subject matter.

FIG. 5 illustrates a method for providing augmentation based learning content, in accordance with certain embodiments of the present subject matter.

### DETAILED DESCRIPTION

Systems and methods for delivering learning content to a user are described. The purpose of present disclosure is to deliver the learning content which may be personalized for the user in a structured manner. Furthermore, the present disclosure also discloses augmenting existing or available learning content before delivering it to the user. The user may be referred as a student/learner in one scenario and an administrator/teacher in another scenario. Usually, the user may have to rely on learning sources authorized or recommended by authorizing bodies including universities, educational institutes, educational boards, etc. Further, the learning sources may comprise physical text books, articles, research papers, white papers, e-articles, e-books, video courses, presentations, Internet web pages, intranet web pages, computer-based training (CBT) courses, learning management software (LMS), or other type of learning materials authorized by an authority. According to some embodiments of present subject matter, learning sources referred by the user may be non-authorized learning sources available in an online and offline environment. Due to such reliance on these learning sources, the user may be unable to fulfill his/her requirements (e.g., learning requirements or administrative requirements). Further, different users may have different learning approaches/learning styles which may also not match by relying solely upon these learning sources. To overcome such limitations, the present disclosure discloses augmentation of these learning sources and thereafter delivers the augmented learning content to the user based on his/her requirements.

In an administrator mode, a page referred by the user while accessing the learning source may be identified or located. From the page identified, one or more topics may be extracted from the page, and the topics may be associated with a particular subject of user's interest. The topics may be extracted based on text present on the page using a Named Entity Recognition (NER) technique. In one example, considering “history” as a subject, the topics may be like person, place, and events. More specifically, “Genghis Khan” as the person, “Agra” as the place, and “Battle of Panipat” as the event. After extracting the topics, different information layers may be generated for presenting the learning content to the user (in the learner mode) in a sequential and structured manner. The information layers may be defined in different categories, and in each category the learning content may be populated and presented to the user (in the learner mode). Some examples of layers are Wikipedia, Videos, Pictures, Blogs, Books, Legacy, Art and Literature, Map, Timeline, Presentations, Lectures, Forums, and Thesaurus.

Once the information layers are generated, an automated search may be performed to retrieve learning content from online and offline sources like the Internet or an internal database of a system, respectively. Based on the search, the learning content retrieved may be populated in the information layers. After populating the information layers, the user (learner) may interact with the system in a learner mode to receive more detailed information about the topic “Battle of Panipat” apart from what is present in the learning sources (e.g., physical text book, articles, research papers, white papers, e-articles, e-books, a video courses, presentations, Internet web pages, intranet web pages, computer-based training (CBT) courses, learning management software (LMS) etc.). In the learner mode, the user may receive the detailed information through the information layers populated with the learning content in a structured manner. For delivering the detailed information, a profile of the user in the learner mode may be generated. Based on the generated profile, the information layers along with the learning content may be prioritized in a sequential and structured manner in order to be delivered to the user in the learner mode. Further, the generation of the layers leads to faster computing/processing of the system as the learning content is populated in the layers in a structured format thus reducing the computing time required by the system for arranging the learning content in the structured way.

While aspects of the above-described system and method for delivering learning content to the user may be implemented in any number of different computing systems, environments, and/or configurations, the embodiments are described in the context of the following exemplary system.

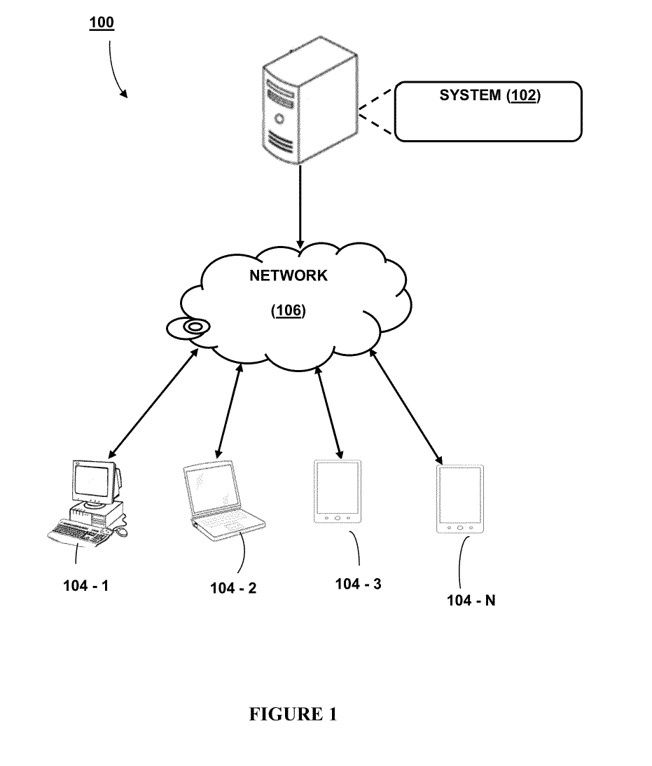

Referring to FIG. 1, a network implementation 100 of system 102 for providing augmentation based learning content is illustrated, in accordance with certain embodiments of the present subject matter. In one embodiment, the system 102 facilitates the learning content in a structured manner. Although the present subject matter is explained considering that the system 102 is implemented for providing augmentation based learning content on a server, it may be understood that the system 102 may also be implemented in a variety of computing systems, such as a laptop computer, a desktop computer, a notebook, a workstation, a mainframe computer, a server, a network server, a tablet, a mobile phone, and the like. In one embodiment, the system 102 may be implemented in a cloud-based environment. It will be understood that the system 102 may be accessed by multiple users through one or more user devices 104-1, 104-2 . . . 104-N, collectively referred to as user 104 hereinafter, or applications residing on the user devices 104. Examples of the user devices 104 may include, but are not limited to, a portable computer, a personal digital assistant, a handheld device, and a workstation. The user devices 104 are communicatively coupled to the system 102 through a network 106.

In one implementation, the network 106 may be a wireless network, a wired network or a combination thereof. The network 106 may be implemented as one of different types of networks, such as an intranet, a local area network (LAN), a wide area network (WAN), the Internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

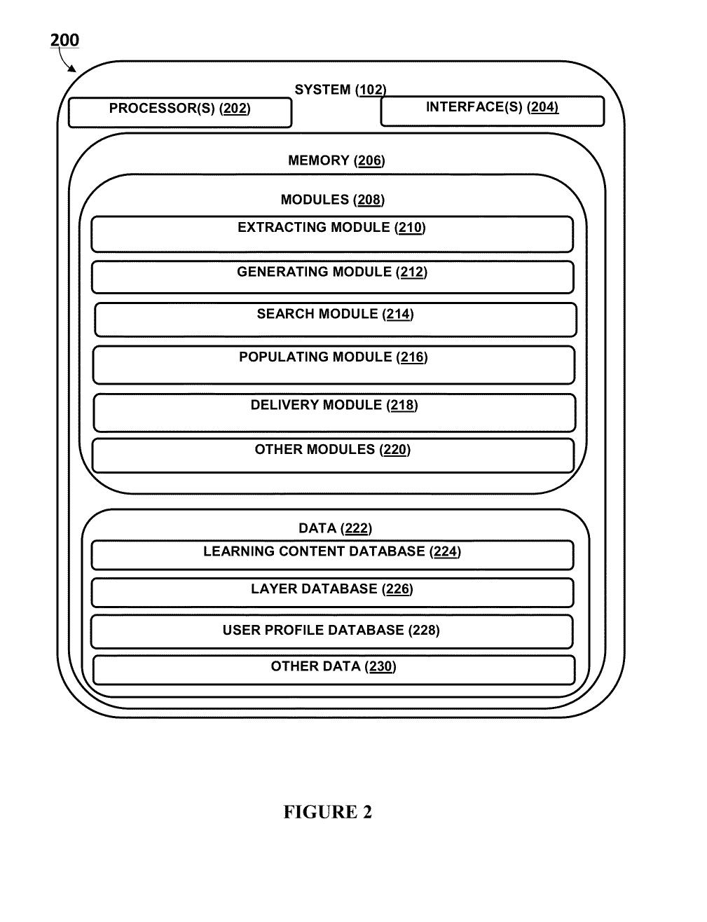

Referring now to FIG. 2, the system 102 is illustrated in accordance with certain embodiments of the present subject matter. In one embodiment, the system 102 may include at least one processor 202, an input/output (I/O) interface 204, and a memory 206. The at least one processor 202 may be implemented as one or more microprocessors, microcomputers, microcontrollers, digital signal processors, central processing units, state machines, logic circuitries, and/or any devices that manipulate signals based on operational instructions. Among other capabilities, the at least one processor 202 is configured to fetch and execute computer-readable instructions or modules stored in the memory 206.

The I/O interface 204 may include a variety of software and hardware interfaces, for example, a web interface, a graphical user interface, and the like. The I/O interface 204 may allow the system 102 to interact with a user directly or through the client devices 104. Further, the I/O interface 204 may enable the system 102 to communicate with other computing devices, such as web servers and external data servers (not shown). The I/O interface 204 may facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium or computer program product known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, compact disks (CDs), digital versatile disc or digital video disc (DVDs) and magnetic tapes. The memory 206 may include modules 208 and data 222.

The modules 208 include routines, programs, objects, components, data structures, etc., which perform particular tasks or implement particular abstract data types. In one implementation, the modules 208 may include an extracting module 210, a generating module 212, a search module 214, a populating module 216, a delivery module 218, and other modules 220. The other modules 220 may include programs or coded instructions that supplement applications and functions of the system 102.

The data 222, amongst other things, serves as a repository for storing data processed, received, and generated by one or more of the modules 208. The data 222 may also include a learning content database 224, a layer database 226, a user profile database 228, and other data 230.

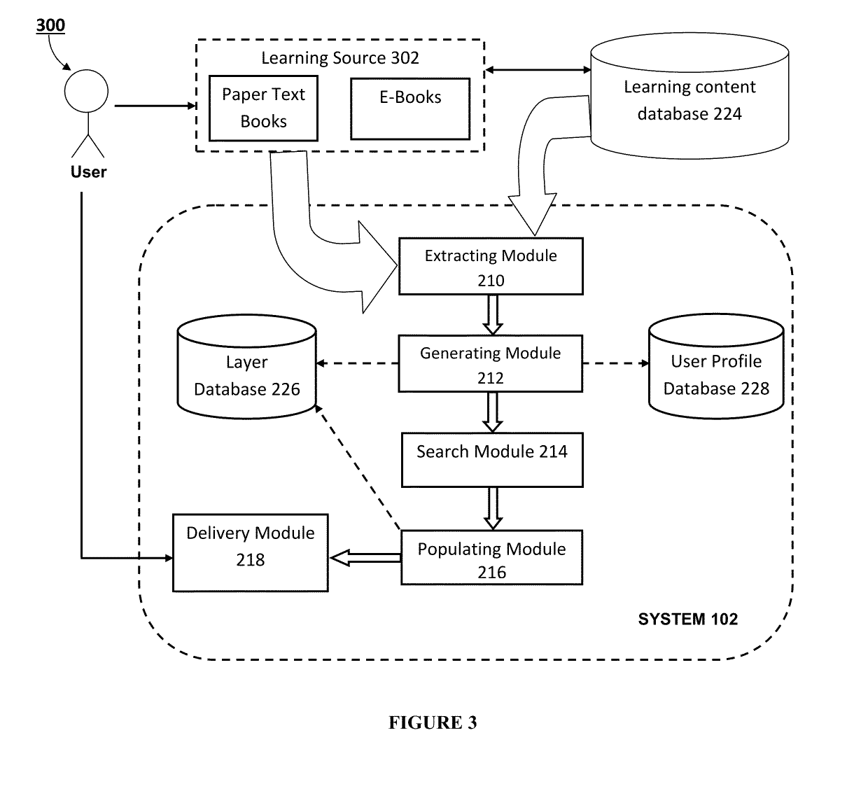

Referring now to FIG. 3, a detailed working of the system 102 is illustrated in accordance with an embodiment of the present subject matter. The system 102 is provided for delivering augmentation based learning content to a user. The learning content delivered may be personalized to the user. In today's learning environment, the user may have to rely on learning source 302 which may be authorized by different authorizing bodies or institutes or boards or universities. The learning source 302 may comprise paper text books, articles, research papers, white papers, e-articles, e-books, video courses, presentations, Internet web pages, intranet web pages, computer-based training (CBT) courses, learning management software (LMS) or other types of learning sources which the user may refer for learning. While referring to such a learning source 302, the user may be restricted in enhancing his/her knowledge. The user may require additional information or additional learning content to overcome such restrictions. Further, the learning content required may have to be specific in order to match user's learning style or learning capability i.e., learning content should be personalized to the user.

To provide such personalized learning content, one of a module i.e., an extracting module 210 may be configured to identify a page being referred by the user while accessing the learning source 302. Further, one or more topics from the page may be extracted, and the topics may be associated with a particular subject of user's interest. The, learning source 302 comprises paper text books, articles, research papers, white papers, e-articles, e-books, video courses, presentations, Internet web pages, intranet web pages, computer-based training (CBT) courses, learning management software (LMS), and other types of learning sources.

According to an embodiment of the present subject matter, when the user is referring the e-books from the user device 104, he/she may select a particular topic associated with a particular subject for learning. Based on the selected subject, related e-books may be displayed on the user device 104 to the user. The user may select and start reading a particular e-book of his/her choice. The e-book comprises a number of pages which may be flipped by the user. While reading the e-book, the user may require additional details or clarification on the topics in order to grasp the topic in a greater detail. In such situation, the extracting module 210 may be configured to detect current page being read or referred by the user by using a page detection mechanism. The page detection mechanism may easily locate the current page (which the user is reading) and can proceed for further analysis. Alternatively, when the user is referring the text paper book i.e., a physical book, the page detection mechanism may have to interact with an image capturing unit like camera, webcam, or other types of image capturing units attached to the user device 104 for the detection of the current page which is being read or referred by the user.

In such scenario, the image capturing unit (not shown in figure) of the user device 104 may be enabled to capture images of one or more pages of the paper text book being referred or accessed by the user. Upon capturing of the image of the page of the paper text book, the image is further processed through the page detection mechanism. Thus, in both the cases i.e., when the user is referring the e-book or the paper text book, the image of the current page (which the user is reading) may be captured for being processed by the extracting module 210. Further, the extracting module 210 matches the image captured for the current page with the learning content database 224. The learning content database 224 comprises previously stored images of the learning sources i.e., images of the e-books and the paper text books along with their page numbers.

Thus, by matching the image of the current page captured with the image of a reference page stored in the learning content database 224, the extracting module 210 may be able to detect or identify the exact page which the user is reading. After the page is identified, the extracting module 210 may be further configured to extract the one or more topics from the page detected. Further, the extraction of the one or more topics may be performed in an offline or an online environment. In the offline environment, the user in an administrator mode can define one or more topics based on his/her past experience on the particular subject. Further, the extraction of the one or more topics may also be performed while the user in a learner mode is reading a particular page of the paper text book or the e-book.

According to some embodiments, the user in the learner mode may also be facilitated to provide a particular topic of his/her own choice. Based on the topic provided by the user, the system 102 may be further configured to generated information layers and populate the information layers with learning content. According to embodiments of the present subject matter, the topics may be extracted from a text of the page detected by using any one of a Named Entity Recognition (NER) technique. It may be noted to one skilled in the art that the system 102 may use other types of techniques/mechanism for identifying the topics from the page. For example, when the user is reading the subject like “History,” the topics may be events, places and person, where the event may be “The battle of Panipat,” the place may “Delhi,” and the person may be “Genghis Khan”. It may be noted that, according to embodiments of the present subject matter, there may number of different topics which may extracted by the extracting module 210 based on the subject being read by the user. Thus, upon extracting the topics, a generating module 212 may be configured for generating one or more information layers corresponding to the one or more topics.

According to the embodiments of the present subject matter, the one or more layers may be generated or defined as a meaningful abstraction of information built over the one or more topics of the learning source 302. In an embodiment, the meaningful abstraction of the information indicates that the one or more layers to be generated may be generated on the basis of the subject or topic being read by the user, and one or more layers generated may be stored in a layer database 226 of the system 102. For example, the one or more layers generated for the subject “History” may be “Wiki,” “Books,” “Timelines,” “Blogs,” “Pictures,” etc., whereas, the one or more layers generated for the subject “Google Maps” may be “Streets,” “Maps,” “Shops,” “Restaurants,” “ATMs,” “Real-time traffic information,” “Photos,” and “Wiki”. It may be clearly observed that layers such as, for example, “Shops,” “Streets,” “Restaurants,” and “ATMs” will be only generated when the subject chosen is “Google Maps” and not “History”.

According to embodiments of the present subject matter, the one or more information layers may also be generated by using previously stored layers stored in the layer database 226 based on the subject being read by the user. Some examples of the information layers for the subject “History” may be Wikipedia, Videos, Pictures, Blogs, Books, Legacy, Art and Literature, Map, Timeline, Presentations, Lectures, Forums and Thesaurus. It may be noted that, according to the embodiments of the present subject matter, the information layers may differ from one subject/topic to the other. In an another embodiment of the present subject matter, considering an example of a subject “Computer Science” having a topic “Object oriented programming (OOPs)”, the layers generated may comprise “real time applications of the OOPs”, “explanation of the OOPs using analogy”, “Frequently Asked Questions (FAQs) related to the OOPs”, “Code related to the OOPs”, and “Schematic diagram” for the OOPs.

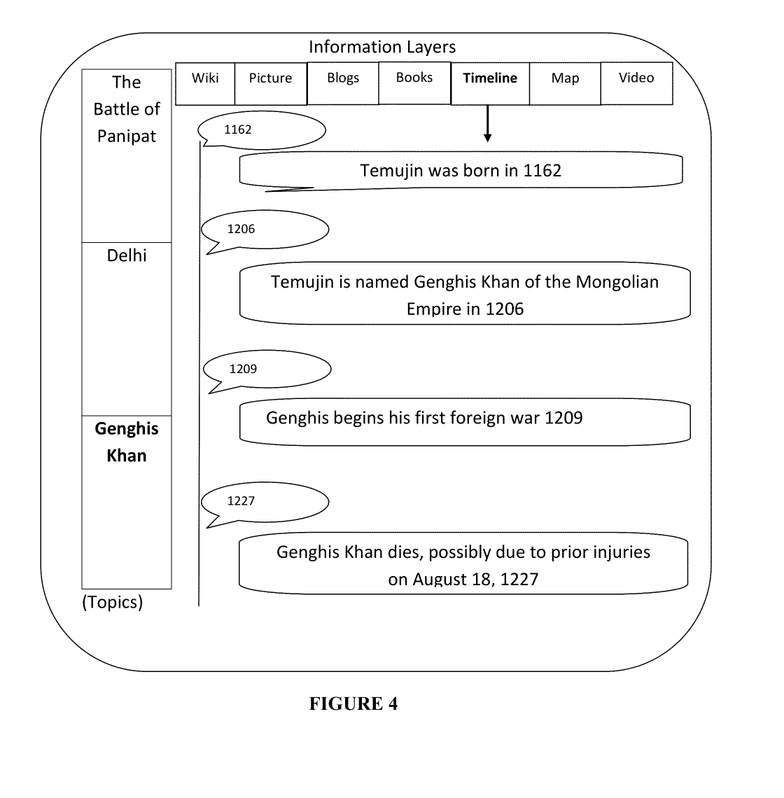

The interface representing the generation of information layers may be relative to one or more topics. For example, the information layers generated corresponding to the topics “The battle of Panipat,” “Delhi,” and “Genghis Khan” are shown in FIG. 4. As shown in FIG. 4, the information layers may be “Wiki,” “Pictures,” “Blogs,” “Books,” “Timelines,” and “Maps”. Further, it can be observed from FIG. 4 that the “Timeline” information layer automatically displays timelines with descriptions related to historical events associated with the life of the topic (e.g., “Genghis Khan”). Thus, by this way, the system 102 displays the relevant information related to the different topics in a structured and sequential manner which ultimately helps the user to enjoy/experience an improved user-interface. In one embodiment, the information layers displayed to the user may be dynamically restructured and/or rearranged based on the user profile. More particularly, the information layers arranged as tiles may dynamically switch individual positions on the interface and/or be replaced with other information layers in real time based on the user profile. In one example, for a user A having a user profile A, the information layers displayed on the interface may be different as compared to user B having a user profile B.

In one embodiment, the generating module 212 may be further configured to generate a profile of the user based on one or more attributes indicating a learning style or learning capability of the user. The one or more attributes may comprise at least one combination of “Extravert OR Introvert”, “Sensing OR Intuition”, “Thinking OR Feeling”, and “Judging OR Perceiving”. It may be noted that, according to embodiments of the present subject matter, there may be other attributes which may be used for defining the user's personality. Thus, the profile generated for the user is stored in a user profile database 228 of the system 102. Both, the information layers and the profile generated may be used for personalizing the learning content.

Further, a search module 214 may be configured to perform a search on one or more resources through a network 106 such as Internet, intranet or other types of online resources to fetch/retrieve the learning content. The learning content retrieved may be based on the one or more topics extracted corresponding to the particular subject. It may be noted that, the search module 214 may also be configured to perform the search on an offline resources. The offline resources may be internal databases stored in memory 206 of the system 102, and the internal databases may comprise relevant information which may be required for facilitating the learning content to the user. Thus, the current page of the learning source may get augmented by performing the search (online or offline or both) and fetching the learning content based on the search performed.

The learning content retrieved from different resources may be collected randomly i.e., in an unstructured form. This may lead to increase in computing/processing time while presenting or delivering the learning content to the user based on user's requirement. In order to present the learning content in a structured manner, a populating module 216 may be configured to populate the one or more information layers with the learning content retrieved from the different resources. Further, the populating of the information layers may be performed in an offline and an online environment. In the offline environment, when the user (learner) is not interacting with the system 102, the populating of the information layers with learning content may be performed periodically. The learning content fetched may be stored in the internal database of the system 102. According to some embodiments, the learning content populated in the information layers may be verified by the administrator in the offline environment. When the user in the learner mode interacts with the system 102, he/she may not have to wait for the information layers to get populated with the learning content. The populating module 216 may either populate the information layers with learning content fetched from the online resources or learning content stored in the internal databases of the system 102 in the offline environment. Thus, the populating of the learning content in different information layers results in saving the computing/processing time of the system 102 while delivering the learning content to the user, based on the user's learning style. It may be noted to a person skilled in art that for the each topic extracted, there may be learning content available in different information layers. According to embodiments, the information layers may get populated for the each topic by using different resources. In one example, for the topic “Battle of Panipat”, the “Books” layer may be populated by performing a custom query to Google Books. Therefore, this approach may present a systematic and structured way to provide the learning content to the user.

After populating the learning content, the delivery module 218 may be configured to deliver the learning content to the user by personalizing the learning content according to profile of the user stored in a user profile database 228. The user profile database 228 may be configured to store profiles for different users which may be interacting with the system 102. Further, the profile of the user may be created on basis of the user's learning style or the user's learning capability. Further, the profile of the user may also be created on basis of user's personal details previously stored in the user profile database 228. The user's personal details may comprise information about one or more user characteristics defining the user's personality. The information may further include one or more attributes which may define the user's personality. Further, the attributes may comprise at least one combination of “Extravert OR Introvert”, “Sensing OR Intuition”, “Thinking OR Feeling”, and “Judging OR Perceiving”. Thus, the delivery module 218 personalize the learning content by selecting and prioritizing the information layers having the learning content populated corresponding to the topics extracted with the profile of the user. Here, the learning content populated in the layers is matched with the profile of the user and hence, the layers get prioritized on the basis of user's requirement. For example, if the user is more comfortable with videos (on basis of profile of user) for learning a particular topic associated with a subject, then learning content present in the “Videos” layer may be prioritized and delivered to the user. Thus, by matching and prioritizing the layers with the profile, learning content are provided to the user. After the learning content being matched with the profile of the user, i.e., the learning content which specific to the user's learning style or the user's learning capability may be displayed to the user on a user-interface of the user device 104.

According to embodiments of present subject matter, the system 102 may work in two different modes i.e., “Administrator mode” and “User mode”. Depending upon the two modes, the operation of the system 102 may vary. For example, in the User mode, the system 102 may perform different operations for assessment of the user's personality on basis of different parameters. In an embodiment of the present subject matter, the system 102 may use Myers-Brigg Type Indicator (MBTI) test for assessing the user's personality. It may be noted that, the present subject matter may be further enabled for using other techniques for assessing the user's personality. Further, in the User mode, a feedback mechanism may be provided for the users (learners) for enabling them to provide their feedback on the particular subject or topic being read by them. Through the feedback mechanism, the user may add/deleted/modify content in the learning content. Similarly, in the “Administrator mode”, the system 102 may provide user-testing mechanism configured for testing the user's knowledge or understanding on a particular subject or a topic. The user-testing mechanism may create questionnaires or puzzles or other type of materials which may be used for testing the user's knowledge or skills on the particular subject or the topic. The user-testing mechanism may help the user in the Administrator mode in deciding on the learning content to be provided to the user (learner) based on his/her skills.

According to embodiments of the present subject matter, the system 102 may identify the users referring the same learning content and further may invite the users on a common platform to enable them to share their views, to chat, and to start a discussion on a specific topic. Further, according to an embodiment of the present subject matter, the system 102 may also create an in-built user-community platform configured for enhancing the user learning. The user-community platform may enable grouping a plurality of users into one or more groups on basis of profiles, learning capabilities, interests on particular subjects and/or topics, and learning content. In one embodiment, the system 102 enables the user to perform a search on the user-community platform in order to identify a group matching with the profile of the user. Based upon the matching of the profile of the user with the group, the learning content corresponding to the group identified may be provided to the user. During the search and identification of the group, the system 102 may also assign a score to each of the groups based on requirements of the user. The group having highest score may be identified and accordingly, the learning content corresponding to the group identified may be provided to the user. This further enables in reduction of processing time of the system 102 since rather than retrieving the learning content from the Internet, the system may retrieve the learning content stored in the memory 206 of the system 102 depending on the group identified relevant to the user's or learner's requirements from the user-community platform. Specifically, the processing time required by the system 102 in performing search on the Internet for the retrieval of the learning content may be conserved.

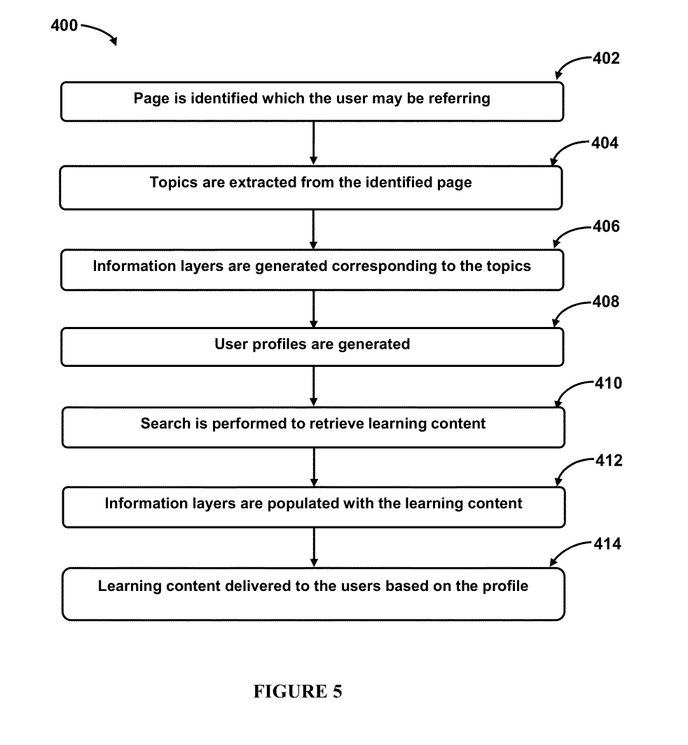

Referring now to FIG. 5, the method for providing augmentation based learning content to the user based on the user's learning style is shown, in accordance with an embodiment of the present subject matter. The method 400 may be described in the general context of computer executable instructions. Generally, computer executable instructions can include routines, programs, objects, components, data structures, procedures, modules, functions, etc., that perform particular functions or implement particular abstract data types. The method 400 may also be practiced in a distributed computing environment where functions are performed by remote processing devices that are linked through a communications network. In a distributed computing environment, computer executable instructions may be located in both local and remote computer storage media, including memory storage devices.

The order in which the method 400 is described is not intended to be construed as a limitation, and any number of the described method blocks can be combined in any order to implement the method 400 or alternate methods. Additionally, individual blocks may be deleted from the method 400 without departing from the spirit and scope of the subject matter described herein. Furthermore, the method can be implemented in any suitable hardware, software, firmware, or combination thereof. However, for ease of explanation, in the embodiments described below, the method 400 may be considered to be implemented in the above described system 102.

At block 402, a page may be identified which a user may be referring while accessing a learning source 302. The learning source 302 may comprises a paper text books, articles, research paper, white paper, e-articles, e-books, video courses, presentations, Internet web pages, intranet web pages, computer-based training (CBT) courses, learning management software (LMS) or other types of learning sources.

At block 404, topics may be extracted from the page identified. The topics may be extracted based on a subject referred by the user. For example, for the subject like “History”, the topics extracted may be events, places and people, where the event may be “The battle of Panipat”, the place may “Agra” and the name may be “Genghis Khan”.

At block 406, layers may be generated corresponding to the topics extracted, and the topics are associated with a particular subject of user's interest. In one example, the layers generated for the subject “History” may be Wikipedia, Videos, Pictures, Blogs, Books, Legacy, Art and Literature, Map, Timeline, Presentations, Lectures, Forums and Thesaurus. According to the embodiments of the present subject matter, the layers may be defined as different categories of information being clubbed in a particular format.

At block 408, a profile of the user may be generated based on one or more attributes indicating a learning style of the user.

At block 410, a search may be performed on one or more resources based on the topics extracted. Further, the search performed results in retrieval of the learning content.

At block 412, the learning content retrieved may be populated in the information layers generated at the block 406. Thus, the populating of the learning content facilitates arrangement of the learning content in a structured manner.

At block 414, the learning content populated in the information layers may get matched with the profile of a user stored in user profile database 228. Based on the matching, the layers get prioritized according to the profile of the user. Thus, based on the matching done, a learning content may be personalized and displayed to the user. Thus, the learning content may be specific to the user's requirement or user's learning style/capability.

Although implementations for methods and systems for providing a personalized learning content have been described in language specific to structural features and/or methods, it is to be understood that the appended claims are not necessarily limited to the specific features or methods described. Rather, the specific features and methods are disclosed as examples of implementations for determining the personalized learning content based on profile of the user and displaying such personalized learning content to the user.

What is claimed is:

1. A method for delivering learning content to a user, the method performed by at least one processor and comprising:
identifying a page of a learning source being accessed by the user;
extracting at least one topic from the page, the topic being associated with a subject of the user's interest;
generating one or more information layers corresponding to the topic, the one or more information layers indicating an abstraction of information relating to the topic,
generating a profile of the user based on one or more attributes indicating a learning style of the user;
searching for one or more resources based on the topic, the search resulting in retrieval of the learning content;
populating the one or more information layers with the learning content; and
delivering, via the one or more information layers, the learning content to the user based on the profile of the user.

2. The method of claim 1, wherein the page is identified by matching the page with a reference page stored in a learning content database.

3. The method of claim 1, wherein the learning source comprises at least one of a physical text book, an article, a research paper, a white paper, an electronic article, an e-book, a video course, a presentation, an Internet web page, an intranet web page, a computer-based training (CBT) course, and a learning management software (LMS) program.

4. The method of claim 1, wherein the topic is extracted from the page using Named Entity Recognition (NER).

5. The method of claim 1, wherein the one or more attributes comprise at least one of an extravert, an introvert attribute, a sensing attribute, an intuition attribute, a thinking attribute, a feeling attribute, a judging attribute, and a perceiving attribute.

6. A system for delivering a learning content to a user, the system comprising:
a memory device that stores a set of modules; and
at least one processor that executes the modules, the modules including:
an extracting module configured to:
identify a page of a learning source being accessed by the user, and
extract at least one topic from the page, the topic being associated with a subject of the user's interest;
a generating module configured to:
generate one or more information layers corresponding to the topic, the one or more information layers indicating an abstraction of information relating to the topic, and
generate a profile of the user based on one or more attributes indicating a learning style of the user;
a search module configured to search one or more resources based on the topic, the search resulting in retrieval of the learning content;
a populating module configured to populate the one or more information layers with the learning content; and
a delivery module configured to deliver, via the one or more information layers, the learning content to the user based on the profile of the user.

7. The system of claim 6, wherein extracting module is configured to identify the page by matching the page with a reference page stored in a learning content database.

8. The system of claim 6, wherein the learning source comprises at least one of a physical text book, an article, a research paper, a white paper, an electronic article, an e-book, a video course, a presentation, an Internet web page, an intranet web page, a computer-based training (CBT) course, and a learning management software (LMS) program.

9. The system of claim 6, wherein the extracting module is configured to extract the at least one topic from the page using Named Entity Recognition (NER).

10. The system of claim 6, wherein the one or more attributes comprise at least one of an extravert, an introvert attribute, a sensing attribute, an intuition attribute, a thinking attribute, a feeling attribute, a judging attribute, and a perceiving attribute.

11. A non-transitory computer readable medium storing machine readable instructions executable by one or more processors for:
identifying a page a page of a learning source being accessed by a user;
extracting at least one topic from the page identified, the topic being associated with a subject of the user's interest;
generating one or more information layers corresponding to the topic, the one or more information layers indicating an abstraction of information relating to the topic,
generating a profile of the user based on one or more attributes indicating a learning style of the user;
searching for one or more resources based on the topic, the search resulting in retrieval of the learning content;
populating the one or more information layers with the learning content; and
delivering, via the one or more information layers, the learning content to the user based on the profile of the user.

12. The computer readable medium of claim 11, wherein the instructions include identifying the page by matching the page with a reference page stored in a learning content database.

13. The computer readable medium of claim 11, wherein the learning source comprises at least one of a physical text book, an article, a research paper, a white paper, an electronic article, an e-book, a video course, a presentation, an Internet web page, an intranet web page, a computer-based training (CBT) course, and a learning management software (LMS) program.

14. The computer readable medium of claim 11, wherein the instructions include extracting the topic from the page using Named Entity Recognition (NER).

15. The computer readable medium of claim 11, wherein the one or more attributes comprise at least one of an extravert attribute, an introvert attribute, a sensing attribute, an intuition attribute, a thinking attribute, a feeling attribute, a judging attribute, and a perceiving attribute.
